(19) United States
(12) Patent Application Publication
(10) Pub. No.: US 2015/0186894 A1
(43) Pub. Date: Jul. 2, 2015

(54) LOCATE TICKET MANAGEMENT

(71) Applicant: Stake Center Locating, Inc., Salt Lake City, UT (US)

(72) Inventor: David B. Mosier, Clearfield, UT (US)

(73) Assignee: Stake Center Locating, Inc., Salt Lake City, UT (US)

(21) Appl. No.: 14/145,359

(22) Filed: Dec. 31, 2013

(51) Int. Cl. G06Q 30/00; G06K 9/62; G06F 17/30; G06Q 50/08

(52) U.S. Cl. CPC G06Q 30/016; G06Q 50/08; G06K 9/6202; G06F 17/30247

(57) ABSTRACT

In one example, a location services method for obtaining and disseminating location data concerning an underground object includes receiving a ticket requesting location services for an under object at a designated site, and sending ticket information to a remote terminal. A location services package corresponding to the ticket is received from the remote terminal and includes a sketch in the form of a graphics file that includes endpoints, but fewer than all intervening points between the endpoints, of a line corresponding to a segment of a buried utility located at the designated site. The location services package is stored in a database. Upon receipt of a customer request for information included in the location services package, the location services package is made available to the customer.

### CROSS-REFERENCE TO RELATED APPLICATIONS

This application is related to U.S. patent application Ser. No. 14/______, entitled IMAGE DUPLICATION DETECTION (attorney docket no. 20062.2), and filed the same day herewith. The aforementioned application is incorporated herein in its entirety by this reference.

### FIELD OF THE INVENTION

Embodiments of the present invention relate to locating underground objects. More particularly, embodiments of the invention include systems, hardware, computer-readable media, and methods for providing location data for underground objects.

### BACKGROUND

A variety of different locating technologies are typically used to locate underground objects, such as, for example, cables, wires, pipes, and conduits. For example, a variety of detection devices use radio signals and corresponding reflections to detect underground objects. After locating an object, markings such as spray paint are typically made on the surface to indicate the path of the object through a specified area. During subsequent construction, workers can use the markings to mitigate the possibility of severing cables, breaking pipes, or causing other damage.

Many times, a contractor or corporation may wish to view markings identifying an underground object without having to actually go to the site of the markings. For example, those making decisions may be located a significant physical distance away from a site. Even if physically visiting a site, personnel may wish to subsequently review the observed markings within having to re-visit the site.

In addition to object markings, other information in the environment at and near the underground object may also be relevant to subsequent digging and/or other operations at the site. Without re-visiting a site, personnel may have no way to (re)consider this other information to determine how, when, where digging and other construction is to occur.

### BRIEF SUMMARY OF ASPECTS OF AN EXAMPLE EMBODIMENT

Embodiments of the present invention relate to locating underground objects. More particularly, embodiments of the invention include systems, hardware, computer-readable media, and methods for providing location data for underground objects.

It should be noted that the embodiments disclosed herein do not constitute an exhaustive summary of all possible embodiments, nor does this brief summary constitute an exhaustive list of all aspects of any particular embodiment(s). Rather, this brief summary simply presents selected aspects of some example embodiments. It should be noted as well that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure.

Finally, none of the embodiments embraced within the scope of this disclosure should be construed as resolving, or being limited to the resolution of, any particular problem(s). Nor should such embodiments be construed to implement, or be limited to implementation of, any particular technical effect(s) or solution(s).

In one example implementation, a service provider communicates with an information aggregator which collects and maintains information concerning the location of underground utilities such as water, telephone, cable, gas, sewer and others. When any excavator has a need to dig or disturb the ground, that excavator is required to identify the proposed dig area and request a locate ticket from the information aggregator.

The information aggregator then passes the ticket along to the utility so that the utility can arrange for location and marking of buried utilities in the proposed dig area. The utility may contract with the service provider for the performance of these location services. Because the service provider has access to the utility information provided by the utility, the service provider can locate all the utilities in the proposed digging site.

The service provider assigns the ticket to a locator, who is then able to access the ticket remotely, such as at the proposed digging site, by employing a web based application hosted by the service provider. For example, the locator can remotely access the web based application by remote devices such as a laptop, tablet, or mobile phone. Once on site, the locator can identify and mark any buried utilities and can then upload that information, as well as other information such as sketches and notes for example to the service provider. The actual location of the utilities may or may not match the records maintained by the utility.

In some cases, the locator may make one or more digital sketches of the route taken by a buried utility line. For a variety of reasons, the locator may not take the time to sketch every line but may, instead, simply digitally represent a segment, or segments, of the buried utility line by its start and end points. With this basic defining information, the sketch of the utility line can be digitally recreated later at any desired size or scale. This approach, which can involve the use of vector points, may be advantageous inasmuch as it allows information concerning the sketch to be stored in a relatively compact form.

After the locator has marked the utilities and uploaded all the information gathered at the digging site, the service provider then packages the information received from the locator and stores that information in a database accessible by the utility company. The service provider also communicates a positive response to the utility and to the information aggregator who then communicates that positive response to the excavator who submitted the ticket identifying the proposed dig area, or makes that positive response accessible from the information aggregator's website. The positive response is a communication indicating that the particular utility line has been located and/or marked or is otherwise not in conflict with the proposed digging site.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 discloses aspects of an example organizational structure of entities that may interoperate with each other to provide some or all of the functionality disclosed herein;

FIG. 2 discloses aspects of an example operating environment for at least some embodiments of the invention;

FIG. 3 discloses aspects of an example computing device such as may be employed in various embodiments of the invention;

FIG. 4 is a flow chart disclosing aspects of an example method for ticket processing; and

FIGS. 5a-5b are flow charts disclosing aspects of an example method for performing location services.

### DETAILED DESCRIPTION

Embodiments of the invention include methods, systems, and computer program products for providing and processing location data for underground objects such as utilities.

A. Aspects of an Example Organizational Structure

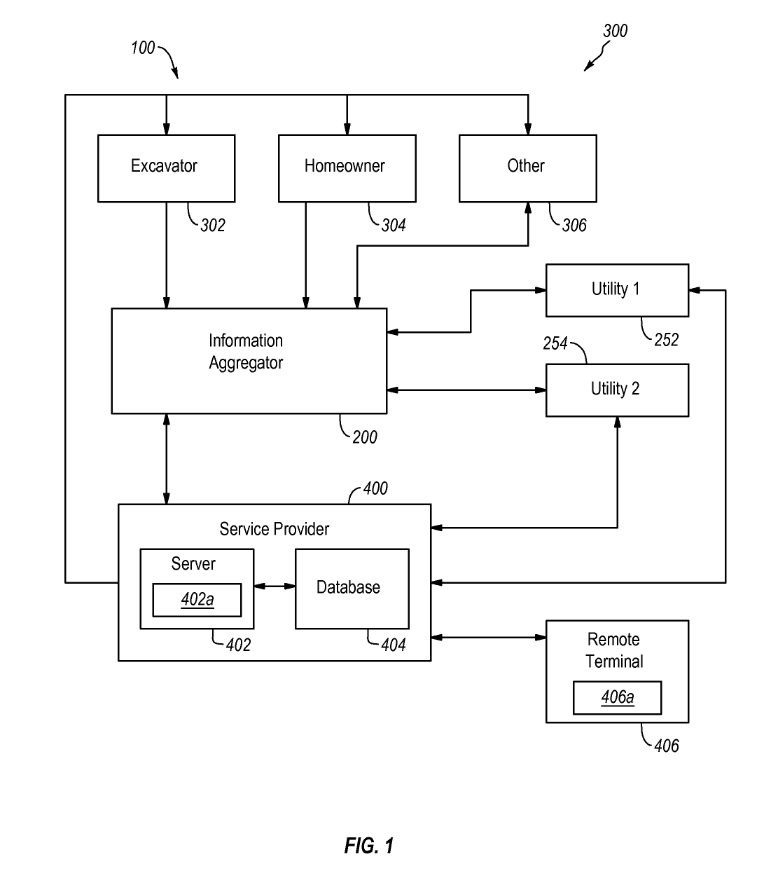

Directing attention first to FIG. 1, details are provided concerning an organizational structure 100 comprising entities that may interoperate to perform some or all of the functionalities disclosed herein. It should be noted that while certain functions or groups of functions are described as being performed by one or more particular entities, the allocation of functions is provided by way of example only, and one or more of the disclosed functions could be allocated to one or more other entities.

In the example of FIG. 1, the organizational structure 100 may include an information aggregator 200 which collects information from a variety of sources such as 252 and 254. The collected information can be maintained by the information aggregator 200, one example of which is Blue Stakes of Utah, Utility Notification Center, Inc. The sources can include a first utility 252, and a second utility 254. Example utilities 252 and 254 may comprise entities, which can be public or private, such as a gas company, an electrical company, a sewer company, a telephone company, a cable company, or a water company. The information provided by entities such as utilities 252 and 254 may include, for example, blueprints and other records that document the location of buried utility lines such as pipes, conduits, cables, or wires.

With the information provided by entities such as utilities 252 and 254, the information aggregator 200 can generate records, maps and other materials that indicate, graphically and/or in other fashions, the location of the buried utility lines of various utilities. Thus, the information aggregator 200 may thus have a relatively complete record of all buried utility lines in any given geographical area within its purview.

In addition to collecting and maintaining information concerning buried utilities, the information aggregator 200 may also receive location requests, which can be in the form of a ticket. The location request may be submitted, for example, by a party who wants to dig in a particular area. Examples of such parties include, but are not limited to, an excavator 302 who is under contract to perform excavation services on behalf of a utility such as utility 252 and utility 254, a homeowner 304 or someone performing work on their behalf, and any other party 306 who wants to dig in an area where buried utilities could be located. In many, if not all, states, local laws require that such a location request be submitted prior to the performance of any excavation work.

The location request may be as simple as a request that all utilities in, or near, a proposed digging site be physically, or otherwise, marked. The location request is typically necessary because the utility 252, for example, likely only knows the location of its own lines, but does not know the location of the lines of other utilities. In its role as an aggregator, the information aggregator 200 has access to the records of all utilities 252 and 254 and as such, may serve as a clearinghouse for all location requests.

Although the information aggregator 200 may have most or all of the information necessary to locate utilities according to a location request, the information aggregator 200 does not perform the actual location services. The information aggregator 200 transmits an incoming location request to the utility 252, or in some instances, where the utility has so authorized, transmits it directly to the service provider 400. The utility 252 may contract with the service provider 400 for performance of the location services.

Because the information aggregator 200 maintains a grid system that indicates all the buried utilities in any given geographical location within its purview, the information aggregator can determine, upon receipt of a location request, whether or not any utilities are buried in the area of interest. If the information aggregator 200 determines that one or more utilities are buried in the area of interest, a conflict is said to have arisen, and the location request received from the excavator 302 is passed by the information aggregator 200 to the utility 252. In some instances, the location request can additionally, or alternatively, be passed by the information aggregator 200 to the service provider 400 if so authorized by utility 252.

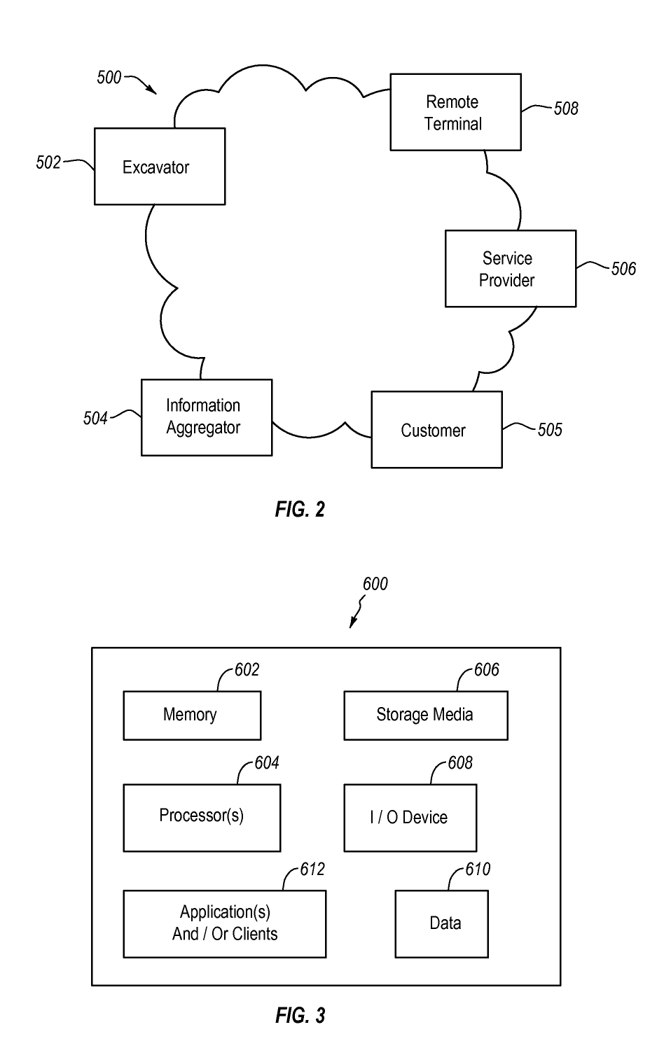

The service provider 400 may be a business entity and/or computing entity, that includes a host such as server 402 that hosts a location services application 402a. The server 402 may communicate with a database 404 of the service provider 400 to store and/or retrieve data which may include, among other things, data relating to the location of underground utilities. As well, the service provider 400 may be associated, and communicate, with one or more remote terminals 406 employed by locators, namely, personnel tasked with locating and marking buried utilities. The remote terminal 406, which may be in the form of a laptop, tablet, mobile phone, or other mobile device, can communicate, wirelessly for example, with the server 402. The remote terminal 406 may include a location services client 406a that operates in conjunction with the location services application 402a of the server 402. A locator can locate and mark utilities in the area of interest, and then transmit location and other information back to the server 400. Further details concerning an example operating environment for the entities disclosed in FIG. 1 are set forth below in the discussion of FIG. 2.

With continued reference to the service provider 400, one or more utilities such as utility 252, and/or any other entity, may contract with the service provider 400 to provide location services for that utility 252 or other entity.

In addition to identifying and marking buried utilities, the service provider 400 can also provide, or otherwise make available, various other information to the utility 252 on whose behalf the location request was submitted. Such information, discussed in more detail elsewhere herein, may include, for example, photos, sketches and notes prepared by the locator. The service provider 400 can then bill the utility 252 for location services performed for the utility 252 by the service provider 400.

The information prepared and collected by the locator may be maintained in the database 404 of the service provider 400 and may be accessible there by the utility 252 for whom the location services were performed. Among other things, this information made available by the service provider 400 to the utility 252 provides visual confirmation to the utility 252 that the requested location services have actually been completed. This information may be useful in the event that, for example, a dispute should arise between the excavator 302 and the utility 252 as to whether or not the utilities have been located and marked.

B. Some Aspects of an Example Operating Environment

With attention now to FIG. 2, details are provided concerning aspects of an example operating environment 500 in connection with which various embodiments of the invention may be employed. The example operating environment 500 may include one or more excavators 502, configured to communicate with an information aggregator 504 which, in turn, can communicate with a customer 505, for example a utility, or with the service provider 506 that is associated with one or more remote terminals 508. The service provider 506 may also communicate with a customer 505.

Some or all of the operating environment 500 may comprise a network, examples of which include, but are not limited to, a Local Area Network (“LAN”), a Wide Area Network (“WAN”), and the internet. Part, or all, of the operating environment 500 may comprise a mobile telephone network. Consistent with the foregoing, communication between and among the entities of the operating environment 500 can take place using wireless and/or hardwired infrastructure(s). By way of illustration, an excavator 502 may send a location request to information aggregator 504 by landline, wireless messaging, or wireless phone call. As another example, the remote terminal 508 may communicate wirelessly with the service provider 506.

In some embodiments, communication between and among entities can take place by way of web based interfaces such as web pages. For example, remote terminal 508 can display a web page that enables a locator to access resources located at, or otherwise associated with, the service provider 506. The web page can be hosted by the service provider 506. As another example, the customer 505 can operate and display a web page that enables the customer 505 to access information located at the service provider 506. Communication between and among entities of the operating environment 500 can take place in other ways as well.

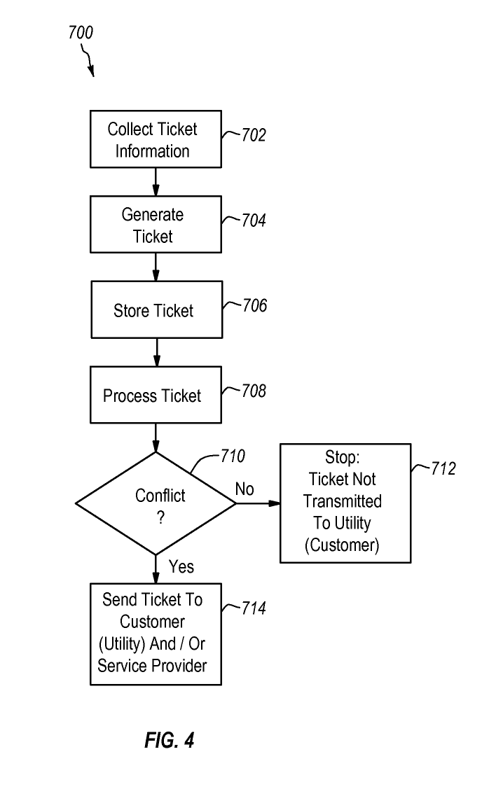

Some, or all, of the elements 500 may comprise elements of a cloud computing environment, although that is not necessary. Further, any one or more of the customer 505, information aggregator 504 and service provider 506 may be implemented as, or comprise, a computing device, one example of which is discussed below in connection with FIG. 3.

Directing attention briefly now to FIG. 3, and with continued reference to FIGS. 1 and 2, details are provided concerning aspects of an example computing device 600 such as may be employed in connection with one or more embodiments of the invention. The example computing device 600 may be a virtual device, or a physical device. Thus, and with reference to FIG. 2, any one or more of the customer 505, information aggregator 504 and service provider 506 may be implemented as, or include, a server that includes any one or more of the components, in any combination, of the example computing device 600. While not necessarily implemented as a server, the remote terminal 508 may include any combination of the elements of the computing device 600. Moreover, any or all of those components can be physical hardware, or may comprise virtual components.

As indicated in FIG. 3, the computing device 600 includes a memory 602 which may comprise RAM and/or ROM. Computer-executable instructions may be stored in the memory 602 and/or elsewhere in the computing device 600. The computing device 600 may also include one or more processors 604 which may be hardware processors operable to execute computer-executable instructions for performing various processes. As well, the computing device 600 may include storage media 606, I/O device 608, and data storage 610. As well, one or more applications and/or clients, generically denoted at 612, may be provided that comprise executable instructions. One example of such an application 612 is a location services application, and one example of such a client 612 is a location services client, examples of both of which are disclosed elsewhere herein.

In at least some instances, the example computing device 600 may comprise a host machine that hosts one or more applications. As such, the computing device 600 can be implemented, by way of example only, as a server (e.g., a file server, an email server), computer (e.g., desktop computers, laptop computers, tablet devices, smart phones), virtual machine, or any combination thereof. Each of the one or more hosts 600 can be associated with its own data. As well, a computing device 600 may generally be any device that includes one or more applications which require communication with devices such as the examples disclosed in FIG. 2. Thus, the computing device 600 may both receive communications from, and transmit communications to, one or more of such devices.

C. Some Aspects of an Example Ticket Processing Method

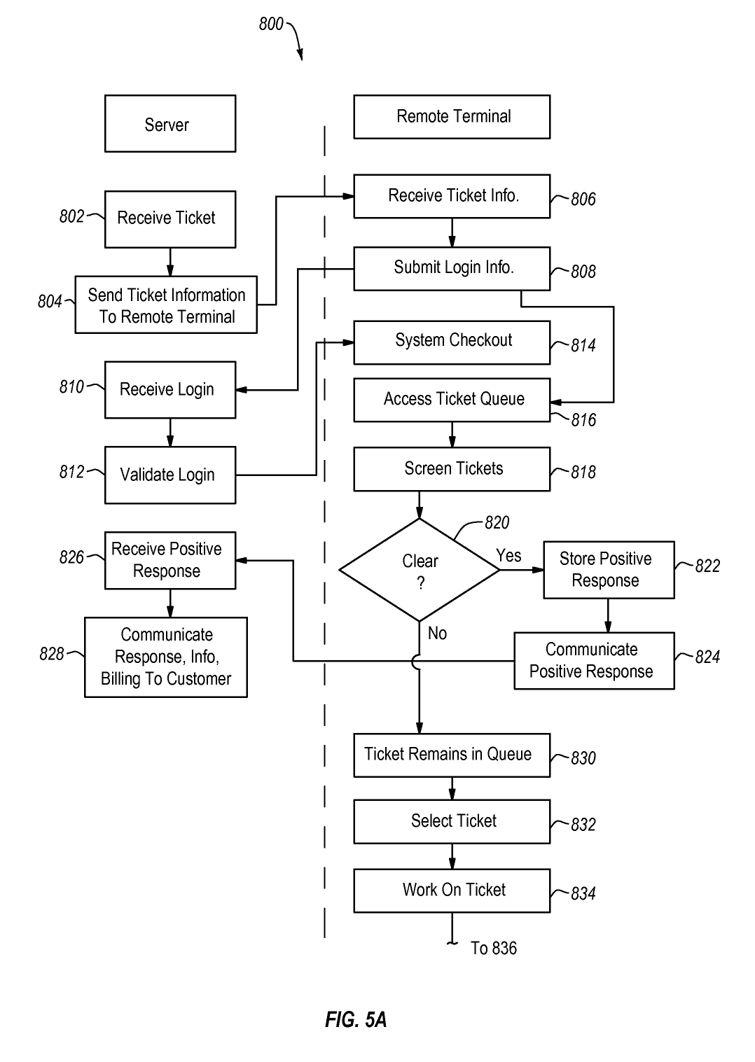

Directing attention now to FIG. 4, details are provided concerning an example method 700 for generating and processing a location request. In the example of FIG. 4, a location request is embodied in the form of a ticket, although location requests may take other forms as well, and the method disclosed in FIG. 4 is provided only by way of example.

The method 700 commences with the collection of ticket information 702 concerning the need of a party, such as an excavator, to identify the location any buried utilities in an area where excavation is to be performed. Such excavation may be required, for example, to install new underground utilities or structures and/or to remove, repair, and/or replace existing underground utilities or structures. For the purposes of the discussion of method 700, the party on whose behalf the request is made will be referred to as the excavator, with the understanding that there are instances where the customer, such as a utility, hires a contract excavator to improve, maintain, repair or install utilities, which contract excavator would submit a dig request to perform such services for the customer utility.

In general, the ticket information may include any information concerning attributes of the geographical location where digging is to take place. Such information can then be used to aid in the location of any buried utilities in the area of interest. Accordingly, a ticket may include, but is not limited to, any combination of one or more of global positioning system (GPS) coordinates, photographs, graphics files, sketches, terrestrial mapping information (e.g., Google earth images), audio files, street address, physical boundaries, type(s) of underground object (e.g., pipe, wire, or conduit), physical features of the surrounding environment (e.g., trees, buildings, or terrain features), and/or any other information that may be aid in the identification and/or location of buried utilities in the area of interest.

A ticket including information such as that noted above can be generated 704 in a variety of ways. For example, the ticket information can be submitted by an excavator to an information aggregator. The information can be submitted as a ticket, or can be assembled together in ticket form by the information aggregator.

Once generated 702, the ticket can be retrievably stored 706 by the information aggregator. The excavator, the customer and/or the information aggregator may maintain copies of the generated tickets in respective databases. If only the information aggregator maintains a copy of the ticket, that ticket may be accessible to the customer, such as by way of a web interface for example. The ticket may also be made available by the information aggregator to the service provider.

The excavator and/or information aggregator may be able to cancel the ticket if it is determined that the ticket was submitted in error, or is no longer required. The information aggregator may append the ticket with various information including, for example, the time and date the ticket was submitted, as well as the entity on whose behalf the ticket was submitted.

As noted elsewhere herein, the ticket may be subjected to processing 708 after receipt by the information aggregator. Such processing 708 may include an evaluation of the ticket information to determine 710 if a conflict exists, namely, whether buried utilities are present in the proposed digging area. If the information aggregator determines that no conflict exists, the process 700 can stop 712. If there is any question as to whether a conflict exists, the process 700 may continue and the ticket is forwarded 714 to the utility, which is then responsible to arrange for performance of location services. Upon, or after, receipt of the ticket, the utility or other customer may arrange with the service provider for performance of location services, one example of a method for which is discussed in more detail below. After arranging with the service provider for the performance of location services, the utility may allow the information aggregator to transmit tickets directly to the service provider.

D. Some Aspects of an Example Location Services Method

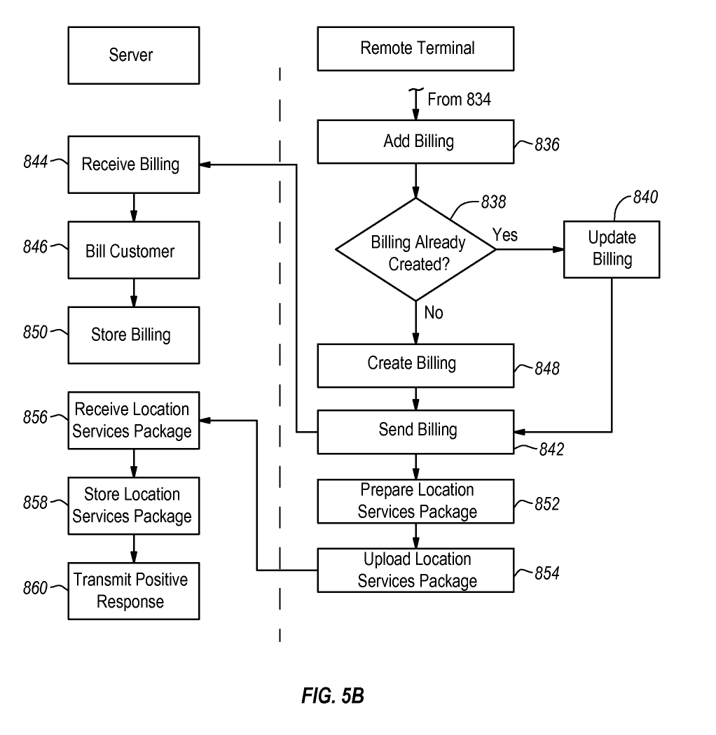

With reference now to FIGS. 5a and 5b, details are provided concerning an example method 800 for performing location services. In at least some embodiments, the method 800 may be performed by and/or at the direction of a service provider. In one particular embodiment, the method 800 is cooperatively performed by a locator operating a remote terminal that is configured for bi-directional communication with a server associated with the service provider. In a more specific implementation of that embodiment, the method 800 may be cooperatively performed in whole or in part by a location services application hosted on a server of the service provider and a corresponding location services client located on the remote terminal. The foregoing is provided solely by way of example however and is not intended to limit the scope of the invention in any way. It should also be understood that the example method disclosed in FIGS. 5a and 5b embraces both a series of communications from the server to the remote terminal and other devices, as well as a series of communications from the remote terminal and other devices to the server.

With particular reference now to FIG. 5a, the method 800 may commence when a ticket is received 802 by a server of a service provider from, for example, a customer such as a utility. In some embodiments, the ticket can alternatively be received at the service provider server from an information aggregator directly if so authorized and arranged by the utility. As noted elsewhere herein, the ticket may be stored at the server. At 804, the ticket can be simply forwarded to the remote terminal, or information can be parsed from the ticket and the parsed information sent to the remote terminal. Transmission 804 of the ticket or ticket information from the server to the remote terminal can be push transmission where the ticket or ticket information is automatically sent, either immediately or according to a predetermined schedule, after receipt by the server. The ticket or ticket information is then received 806 at the remote terminal. This receipt can occur before, or after, a locator has logged onto the server from the remote terminal. Alternatively, the ticket or ticket information can be manually pulled down 806 by a locator, after login, using the remote terminal.

At 808, the locator may submit login information, such as a unique username and password, which is then received 810 by the server. The login information may entered by the locator using a web page interface that is displayed on the remote terminal as a result of the locator initiating a locator session. For example, the mobile device may include an icon that when selected by the user, presents the user with a login screen or box which the user can use to enter his name and password, or other suitable credentials. The login information is validated 812 by the server, and the locator is granted access to the system.

As part of, or separate from, the locator session initiated in connection with the method 800, the locator can perform a variety of miscellaneous tasks. For example, the locator can submit his timecard information, prepare and submit truck inspection reports, order supplies needed to perform location services, and perform damage investigation and reporting concerning the proposed dig site. Information concerning any one or more of the aforementioned tasks, along with notes, photographs, voice memos, and sketches, for example, can be submitted by the locator to the server using the remote terminal. This information can be retrievably stored in a database of the service provider and may be made accessible to a customer such as a utility.

With reference again now to 812, if, for example, the locator has finished work for the day, or is going on a break, the locator can perform 814 a system checkout process which may involve, among other things, adding information concerning the job worked, such as start/stop time with the last address information and mileage, and then saving that information to the database before checking out of the system.

As an alternative to checking out, the locator can access 816 a ticket queue. For example, a ticket queue for that locator may be presented to the locator, such as by visual display on a user interface (UI) of the remote terminal. The tickets in the queue can be presented according to one or more rules or criteria. By way of example, the tickets in the queue can be sorted and presented to the locator by one or more of priority, date of submission, geographical location, requesting customer, or any other criteria. As noted elsewhere herein, not every ticket in the queue necessarily requires location services to be performed. Thus, a locator has the option to screen out any of the tickets in the queue that the locator identifies as not requiring further action.

Accordingly, the locator may then have the option to screen tickets 818 in the queue to determine which ones, if any, can be cleared as not requiring any location services to be performed. Screening a ticket 818 may involve, for example, viewing maps provided by the information aggregator, and/or other information associated with the ticket, to determine if one or more utilities in the dig area should be marked. Additionally, or alternatively, the locator can also rely on his personal knowledge of the geographical area in question to make a screening decision.

If a determination 820 is made that the intended dig area is clear of utilities, the locator can then locally store 822 a positive response at the remote terminal, that is, a response indicating that the area is clear and the digging associated with the ticket can proceed. The locator may then also transmit 824 the positive response to the server. As part of process 822 or 824, or separately, the cleared ticket can be removed from the ticket queue that is assigned to the locator. In some cases, the cleared ticket may remain in the queue for viewing. Such cleared tickets may be designated as such in the queue so that their status will be apparent to a locator who is reviewing the queue.

After receipt 826 of the positive response, the server may communicate 828 one or more of the positive response and billing and other information either directly or indirectly to various parties. For example, in some instances, the server of the service provider may communicate 828 the positive response to the information aggregator, which makes the information available to the excavator who submitted the dig request. In at least some instances, the positive response is the only information communicated to the excavator. As another example, the server may communicate 828 billing information directly, and only, to a customer such as a utility. While, as noted previously, the server of the service provider may, at times, communicate indirectly with a party such as an excavator, the service provider can communicate directly with a party, such as an excavator for example, in certain circumstances. Some examples of such circumstances are addressed below in the discussion of FIG. 5b.

With continued reference now to the method 800, a determination 820 is made instead that the proposed dig area is not clear, or if there is a question as to whether or not the proposed dig area is clear, then the ticket will remain 830 in the queue. At any time, the locator can review the queue and select 832 a ticket to work on.

Depending upon the implementation, a locator may be able to view, and select tickets from, multiple different types of queues. For example, a locator may be able to view, using the remote terminal, a ‘current work’ queue that comprises a list of tickets assigned that locator, but for which the locator has not yet begun work. The locator may also be able to view a ‘previous worked’ queue that comprises a list of cleared tickets. As a further example of a queue type, the locator may be able to view a ‘project tickets’ queue that comprises a list of open tickets for which work has begun but is not yet completed.

As a final example of a ticket queue type that a locator may be able to view, or otherwise access, the locator may be able to view an ‘unassigned tickets’ queue that comprises a list of tickets which the locator is working on, but which have been assigned to another locator. In particular, some projects are sufficiently large that the services of multiple locators are required. However, to aid in tracking of the ticket associated with that project, the ticket is assigned to only one of the locators. Other locators working on that ticket, but to whom the ticket has not been assigned, can view the tickets they are working on but which have been assigned to others. In some cases, the unassigned tickets are not displayed, but a locator can manually enter the ticket number in order to access it. If the ticket has already been opened by another locator on that project, the locator who has manually entered the ticket number may receive a message from the server indicating that. In at least some embodiments, multiple users can simultaneously access, and enter information pertaining to, a single ticket. Final authority over the information entered or otherwise associated with that ticket may rest with the locator to whom the ticket has been assigned.

In other embodiments, there may be only a single queue where all the tickets in the queue include a designator that indicates the status of the ticket. Such a single queue may comprise, for example, any combination of the aforementioned queues. As in the case of other parameters pertaining to the tickets, the tickets in a queue, or queues, can be sorted by the locator according to ticket type, and/or locator to whom the ticket has been assigned.

In any case, once a ticket has been selected 832 by a locator, the locator can then work 834 on that ticket. To work on the ticket, the locator will typically go out to the proposed digging site. As noted elsewhere herein, the ticket can include a variety of information to assist the locator in identifying and marking any buried utilities in the area of interest. In some instances, and as disclosed in the related provisional application incorporated herein by reference, the locator can use a detection device to locate one or more underground utilities. Based on information provided by the detection device, the locator can physically mark the location of the underground utility or utilities. Such physical marking can be any marking that will be visually apparent to personnel in the area and can include, for example, any one or more of flagging, stakes, monuments, and paint.

Once the marking has been completed, corresponding billing information can be associated 836 with the ticket. In some embodiments, the locator can select an ‘add billing’ item from a menu displayed by a UI on the remote terminal. In response to the selection of this menu item, the UI displays a list of all the customers for whom the work defined by the ticket was performed. That is, there may be one customer or multiple customers associated with a single particular ticket. The UI also enables the locator to select one or more customers, such as by checking one or more boxes, to be billed. In general, the manner of billing can be the same for each customer, or can be customer-specific depending, for example, on the terms of the contract between the service provider and the customer.

In at least some instances, billing is not performed until after the work associated with the ticket has been completed. Thus, if the work associated with a ticket extends over multiple days, billing may not be performed until the last day of work, or at some time thereafter. In other cases, work associated with the ticket can be billed on a daily, or other periodic, basis.

The billing information can include as much, or as little, information as desired by the customer and/or the service provider. In some cases, the billing information can include notes from the locator about whether a site visit was required, what was found at the site, and how long the location work took.

If it is determined 838 that billing information has already been created for the ticket, the billing information for that ticket can be displayed by a UI on the remote terminal, and updated 840 by the locator. Billing updates might include, for example, adding or deleting one or more customers to the billing information, or making changes to the amount and/or rate billed. Once the billing information has been updated 840, the billing information can be sent 842 from the remote terminal to the server. After the server receives 844 the billing information from the remote terminal, the server can transmit 846 the billing to the customer(s). Billing 846 of the customer by the service provider can be performed substantially contemporaneously with receipt 844 of the billing information, or can occur later at a specified time and/or date.

If, on the other hand, it is determined 838 that billing information has not already been generated for the ticket, the billing information can be created 848, and then sent 842 by the locator from the remote terminal to the server for transmission 846 to the customer(s). Creation 848 of the billing data may comprise compiling information that includes any one or more of the identity of the customer(s) to be billed, the amount to be billed, the date payment is due, information concerning the location services performed, the identity of the service provider, and payment terms.

In any case, once the customer(s) have been billed 846, the billing information can be stored 850, such as in a database of the service provider. In one variation of the method 800, the billing information can be stored 850 prior to the time that the customer, such as the utility that requested the location services, is billed 846. In yet another variation, the billing information can be stored 850 by, or at the direction of, the locator either just prior to, or just after, the billing information has been sent 842 from the remote terminal to the server. In both of the aforementioned variations, the billing information can be stored 850 in a database associated with the service provider.

In conjunction with the billing of the customer, or before the billing of the customer, or after the billing of the customer, the locator may prepare 852 a location services package that includes information concerning the location services that have been performed. Some, or all, of the location services package can be in digital form such that it is relatively easy to transmit between and among the remote terminal and the server. As noted elsewhere herein, the location package can be stored by the service provider for access by the customer.

Information in the location services package may include, but is not limited to, documentation and other evidence showing that the buried utility, or utilities, have been physically marked. The documentation may include taking digital photographs of the markings and/or the surrounding environment. Voice and other types of memoranda can also be used. Using the location services client on the remote terminal, the locator can associate the photographs with the ticket. For example, the location services client may annotate the photographs, such as by watermarking or in any other fashion, so that it will be apparent as to which ticket the photographs are associated with. When the photographs are uploaded and stored, their file locations are tied to the ticket. This enables the photographs associated with a particular ticket to be retrieved as necessary. If a problem or question arises with respect to a particular ticket, the photograph can be retrieved because of its relationship to the ticket. In one embodiments, storing the ticket and ensuring that the file location is tied to the photograph is independent of any actions performed by the location services client. In other words, the photograph can be further tagged or processed after the photograph has been uploaded from the remote terminal.

The photographs can be annotated with other information as well including, but not limited to, GPS coordinates of the specific location from which the photograph was taken, the name of the locator, and the date and time the photograph was taken. The location services client may additionally, or alternatively, create a unique name for each photograph. To ensure uniqueness of the name, information uniquely associated with the photograph, such as a date and time of the photograph for example, can be hashed or otherwise processed or encrypted, and a unique name assigned to the photograph based on the output of the hashing or other encryption process. The creation of a unique name for a photograph can be performed by the location services client and/or the location services application at the server. In addition, the files may be stored in folders and may be organized by date and by locator to provide uniqueness.

In one example, the photographs may be renamed such that the ticket number is incorporated into the file name. The file name may also incorporate the number of the photograph attached to the ticket. For example, the photograph may be renamed to the corresponding ticket number and an extension showing the number (or other attribute) of photograph. Advantageously, this ensures that the photograph can be accessed by a database query and/or by a file search if necessary.

In some instances, the locator may, in addition to taking photographs, or as an alternative to photographs, prepare sketches which may be in digital form, of the digging site for inclusion in the location services package. The sketches can be two dimensional, or three dimensional. The sketches may, but need not be, drawn to scale. One or more of the sketches may comprise a graphical representation of the marking that has been done, and the sketches can also include physical features of the nearby surroundings. The sketches can be digitally created on a map, such as a map that may have been submitted as part of the original location request from the utility or other customer. The use of a map is not necessary however.

Accordingly, in some instances, the locator can use a graphics application, such as a paint, sketch or draw program on the remote terminal to create sketches of the buried utilities and nearby surroundings which may include, for example, buildings, streets, roads, manholes, signs, sidewalks, paths, and trees and other plants. Such applications may include a symbol legend, color palette, a table of line types and weights, and other tools that enable the locator to create sketches. The graphics application can operate in connection with an input device such as a digital stylus, and may reside on the remote terminal or, alternatively, can be hosted by a server of the service provider and accessible through the remote terminal. The graphics program can include features that enable sketches to be readily drawn, and readily re-created if the need should arise.

For example, some embodiments of the graphics program are operable to store only representative elements of a sketch, rather than the entire sketch. One mechanism to achieve this is the use of vector images and vector points, although any other mechanism that produces comparable results can alternatively be employed.

To illustrate, a locator may sketch a line indicating a length of pipe that is buried. The sketched length of pipe includes a starting point and an end point. The line weight and color of the line in the sketch may correspond to attributes of the buried pipe, examples of which include the material of the pipe, the material conveyed by the pipe, and the owner of the pipe.

While the sketch, as drawn, indicates the entire length of pipe, the graphics program is operable to store only the start and end points, and the attribute information. Because only start and end points are stored, or at least fewer than all the intervening points between the start and end points are stored, the graphics file created as a result of the sketching process may be much smaller and simpler than if all the data points that define the line were stored. Upon retrieval of the graphics file, the line sketch can readily be recreated since the start and end points are known. Moreover, the size of the sketch can be readily scaled up or down once the graphics file has been retrieved. Again, and regardless of scale, the line sketch can be readily recreated from the known start and end points residing in the graphics file. While the foregoing example refers to sketches of buried utilities, it should be understood that the use of start and end points as discussed herein applies as well to any other items the locator may choose to sketch. With continued reference to the preparation of sketches, the locator may also add text notes in the sketch. When the sketch is retrieved, the text notes will be displayed.

At least some embodiments of the location services package include materials in addition to sketches and/or photos of the utility lines, markings, and features of the surrounding area. By way of example, the locator may gather information concerning utility manholes, such as the location, type, size of the manhole, and whether or not the manhole includes a tracer wire such as can be used to trace the extent of the tunnel associated with the manhole. This information can be in the form of a sketch, photograph and/or any other suitable form.

Further at least some embodiments of a location services package include a map error report. A map error report comprises documentation by the locator of any errors in the mapping information received from the information aggregator. By way of example, that mapping information may completely omit part of a buried utility, or may indicate incorrect location information for a buried utility. By documenting these errors and providing a map error report to the information aggregator, such as by way of the server, the service provider can aid in keeping the mapping information of the information aggregator up to date.

Finally, the location services client on the remote terminal may enable a locator to include other miscellaneous information in the location services package. For example, a locator can generate a contractor report that advises a customer that a contractor is planning and/or performing excavation in multiple areas and/or over an extended area that may affect the utilities of the customer.

Once the location services package has been prepared 852, the location services package can then be uploaded 854 from the remote terminal to the server. As part of the processing of the location services package, the locator can digitally sign the location services package.

After receipt 856 of the location services package, the server can retrievably store 858 the location services package. Some or all of the location services package may be transmitted, and/or otherwise made available, to a customer such as a utility on whose behalf the ticket associated with the location services package was generated.

Finally, a positive response can be transmitted 860, or otherwise made accessible, by the server. The positive response is an indication by the service provider affirming that all buried utilities in the area identified on the ticket have been identified and physically marked. The positive response can be transmitted 860 by the server to one or more customers, and/or to the information aggregator. As well, the positive response can be transmitted 860 to the contractor performing excavation.

As previously stated, the location services package may include a photograph or image. Embodiments of the invention may determine whether the image is a duplicate that has already been received by the server. In one example, a photograph signature or a pixel signature is generated. The pixel signature may include one or more pixel values or one or more average pixel values. For instance, the photograph may be divided into a number of areas. An average pixel value is then determined for each area from all of the pixels in the corresponding area. These average pixel values are then stored in a string. The resulting string, which is an example of a photograph or pixel signature, can be compared to similar strings that were generated from other images stored by the server. A match indicates that the photograph is a duplicate of an already existing image. Each area of an image may be associated with one or more average pixel values. All pixel values (e.g., Red, Green, and Blue (RGB)) may be incorporated into a single average pixel value. Alternatively, there may be an average pixel value in each area for each pixel component (a red average pixel value, a green average pixel value, and a blue average pixel value).

By dividing an image into areas and generating at least one average pixel value for each area, the server can identify duplicate images with high certainty.

This process can help prevent errors from occurring. For example, when the location services package is generated, an old image may inadvertently be attached or included. By performing a duplication detection process, the server can determine whether or not the image is the correct image. If a duplication is detected, a request may be generated for the correct photograph. This duplication detection can also be used to ensure that the jobs associated with the tickets are actually performed. This enables the service provider to protect themselves from liability in some instances and enables the service provider to perform quality insurance with respect to any work that is done.

In one example, a database may be used to store the pixel signatures. As a result, a duplicate photograph can be identified without having to access the actual images. This enables the duplication detection to be performed quickly since the comparatively small pixel signatures (compared to the size of the corresponding photograph) can be compared much more quickly. In addition, when the server has stored thousands (or more) of photographs, the ability to detect duplicates quickly can save significant processing time.

As noted earlier, circumstances may arise where it is useful for the service provider to communicate directly with a party such as an excavator, rather than communicating with that party indirectly, such as by way of the information aggregator. One example of such a circumstance is where a buried utility is known or suspected to exist in the proposed dig area but cannot be found by the locator. In this case, once the service provider is notified by the locator that the utility cannot be located, an automated communication can be sent from the service provider to the excavator, informing the excavator that one or more buried utilities cannot be located and that digging cannot proceed unless and until a positive response is received by the excavator by the service provider.

The automated communication can take a variety of forms including, but not limited to, a phone call, text message, email or fax. The communication can be sent in multiple forms, if desired, and can be addressed to the excavator based on contact information provided by the excavator when the dig request was submitted to the information aggregator.

As another example of a circumstance that may arise where it is useful for the service provider to communicate directly with a party such as an excavator, the service provider may be, or become, aware that a utility line has a high profile in the sense that the utility line itself is of extreme value, such as a fiber optic cable and its geographical extent is extensive and likely to be encountered by the excavator at multiple times and/or multiple locations. In this circumstance, the service provider can transmit an automated communication, in a form and manner such as described above, directly to the excavator notifying the excavator that work cannot proceed until a locator is on-site to meet with the excavator and observe the digging. This particular type of notice to the excavator may be referred to as a high profile notice.

It should be noted that the foregoing circumstances are provided solely by way of example and are not intended to limit the scope of the invention in any way. In fact, it may be useful for the service provider to communicate directly with the excavator or other party in various other cases and at various other times as well.

D. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein.

As indicated above, embodiments within the scope of the present invention also include computer storage media, which are physical media for carrying or having computer-executable instructions or data structures stored thereon. Such computer storage media can be any available physical media that can be accessed by a general purpose or special purpose computer.

By way of example, and not limitation, such computer storage media can comprise hardware such as solid state disk (SSD), RAM, ROM, EEPROM, CD-ROM, flash memory, phase-change memory (“PCM”), or other optical disk storage, magnetic disk storage or other magnetic storage devices, or any other hardware storage devices which can be used to store program code in the form of computer-executable instructions or data structures, which can be accessed and executed by a general-purpose or special-purpose computer system to implement the disclosed functionality of the invention. Combinations of the above should also be included within the scope of computer storage media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ can refer to software objects or routines that execute on the computing system. The different components, modules, engines, and services described herein may be implemented as objects or processes that execute on the computing system, for example, as separate threads. While the system and methods described herein can be implemented in software, implementations in hardware or a combination of software and hardware are also possible and contemplated. In the present disclosure, a ‘computing entity’ may be any computing system as previously defined herein, or any module or combination of modulates running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention can be performed in client-server environments, whether network or local environments, or in any other suitable environment. Suitable operating environments for at least some embodiments of the invention include cloud computing environments where one or more of a client or server may reside and operate in a cloud environment.

Finally, those skilled in the art will appreciate that the invention may be practiced in network computing environments with many types of computer system configurations, including, personal computers, desktop computers, laptop computers, tablets, message processors, hand-held devices, multi-processor systems, microprocessor-based or programmable consumer electronics, network PCs, minicomputers, mainframe computers, mobile telephones, PDAs, pagers, routers, switches, underground object sensors, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a server, a location services method for obtaining and disseminating location data concerning an underground object, the method comprising:
receiving a ticket requesting location services for an under object at a designated site;
sending ticket information to a remote terminal;
receiving a location services package from the remote terminal, wherein the location services package corresponds to the ticket and includes a sketch in the form of a graphics file that includes endpoints, but fewer than all intervening points between the endpoints, of a line corresponding to a segment of a buried utility located at the designated site;
storing the location services package in a database;
receiving a customer request for information included in the location services package; and
making at least part of the location services package available to the customer.

2. The method as recited in claim 1, wherein the location services package includes one or more photographs depicting physical markers corresponding to a location of the underground object.

3. The method as recited in claim 1, wherein the graphics file includes no intervening points between the endpoints.

4. The method as recited in claim 1, wherein the buried object is a utility line.

5. The method as recited in claim 1, further comprising, prior to receipt of the location services package:
receiving a login request from the remote terminal; and
validating the login request.

6. The method as recited in claim 1, further comprising, prior to sending ticket information to the remote terminal, assigning the ticket to a locator.

7. The method as recited in claim 1, further comprising transmitting a positive response to an information aggregator to transmit the positive response to a party which has submitted a dig request to which the ticket corresponds, wherein the positive response confirms that locate services have been performed for the locate request.

8. The method as recited in claim 1, further comprising directly communicating with a party which has submitted a dig request to which the ticket corresponds, wherein directly communicating comprises sending an automated communication to the party, and wherein the automated communication comprises any one or more of a phone call, text message, email, or fax.

9. The method as recited in claim 1, wherein the location services package includes a photograph, the method further comprising determining whether the photograph is a duplicate of another photograph already stored in the database.

10. The method as recited in claim 9, further comprising determining whether the photograph is a duplicate by comparing a pixel signature of the photograph to other pixel signatures of other photographs.

11. At a remote terminal, a location services method for obtaining and disseminating location data concerning an underground object, the method comprising:
an act of receiving ticket information from a server, the ticket information including a request for physical marking of a location of the underground object;
receiving sketch data representing the underground object; and
creating a graphics file that includes endpoints, but fewer than all intervening points between the endpoints, of a line corresponding to a segment of a buried utility located at the designated site;
creating a location services package that corresponds to the ticket and includes the graphics file; and
transmitting the location services package to the server.

12. The method as recited in claim 11, wherein the graphics file includes no intervening points between the endpoints.

13. The method as recited in claim 11, further comprising generating one or more photographs depicting physical markers corresponding to a location of the underground object.

14. The method as recited in claim 11, further comprising:
creating or updating billing information associated with the location services package; and
transmitting the billing information to the server.

15. A physical storage device having stored therein computer-executable instructions which, when executed by one or more hardware processors of a computing system, obtaining and disseminating location data concerning an underground object, wherein obtaining and dissemination location data comprises:
an act of receiving ticket information from a server, the ticket information including a request for physical marking of a location of the underground object;
receiving sketch data representing the underground object; and
creating a graphics file that includes endpoints, but fewer than all intervening points between the endpoints, of a line corresponding to a segment of a buried utility located at the designated site;
creating a location services package that corresponds to the ticket and includes the graphics file; and
transmitting the location services package to the server.

16. The physical storage device as recited in claim 15, wherein the graphics file includes no intervening points between the endpoints.

17. The physical storage device as recited in claim 15, wherein obtaining and dissemination location data further comprises generating one or more photographs depicting physical markers corresponding to a location of the underground object.

18. The physical storage device as recited in claim 15, wherein obtaining and dissemination location data further comprises:
creating or updating billing information associated with the location services package; and
transmitting the billing information to the server.

19. The physical storage device as recited in claim 15, wherein:
the computer-executable instructions comprise a portion of a location services client operable to communicate with a corresponding location services application of a server; and
the physical storage device is incorporated in a remote terminal.

20. A server, comprising:
one or more hardware processors; and
a location services application comprising computer-executable instructions which, when executed by one or more of the hardware processors, obtain and disseminate location data concerning an underground objection, wherein obtaining and disseminating location data comprises:
receiving a ticket requesting location services for an under object at a designated site;
sending ticket information to a remote terminal;
receiving a location services package from the remote terminal, wherein the location services package corresponds to the ticket and includes a sketch in the form of a graphics file that includes endpoints, but fewer than all intervening points between the endpoints, of a line corresponding to a segment of a buried utility located at the designated site;
storing the location services package in a database;
receiving a customer request for information included in the location services package; and
making at least part of the location services package available to the customer.

21. The server as recited in claim 20, wherein the graphics file includes no intervening points between the endpoints.

22. The server as recited in claim 20, wherein obtaining and disseminating location data further comprises transmitting a positive response to the customer confirming that the underground object has been located and physically marked.
